(19) United States
(12) Patent Application Publication
(10) Pub. No.: US 2003/0160414 A1
(43) Pub. Date: Aug. 28, 2003

(54) Tie bar made of composite

(76) Inventors: Neoclair Franco Pincerato, Sao Bernardo Do Campo (BR); Ricardo Dos Santos, Sao Bernardo Do Campo (BR)

Correspondence Address: Liniak, Berenato & White, 6550 Rock Spring Drive, Ste. 240, Bethesda, MD, 20817, US

(21) Appl. No.: 10/372,442

(22) Filed: Feb. 27, 2003

(30) Foreign Application Priority Data
Feb. 27, 2002 (BR) PI 0200820-3

(51) Int. Cl. B62D 7/20

(52) U.S. Cl. 280/93.51

(57) ABSTRACT

A tie rod for motor vehicles comprises a rod constructed of polymeric materials or composites, formed through irreversible chemical reactions whereby the connection is crossed between molecular chains of the base polymer constituent of this composite, reinforced with charges in the form of fibers such as fiber glass, carbon fiber, aramide fiber, among others. These rods are coupled to metallic terminals positioned in their extremities, and this coupling can be made through chemical bonding, such as gluing, for example, and/or mechanical bonding, such as pressing or clipping. Threads may be used for the union of the pieces to obtain adjustability of the length of the tie bar according to its application.

### BACKGROUND OF THE INVENTION

1. Field of the Invention

The object of this invention is a tie bar, for utilization in mechanical systems that require connecting elements that make possible rotating and angular movement, more specifically, for application in motor vehicle, constituted of a rod made of polymeric materials.

2. Description of Related Art

Conventional tie bars are generally constructed in form of metallic bodies composed of a rod welded to eyelets disposed at the extremities, to affix components such as plastic bearings, spherical pins, protective hoods, among others that form two ball and socket joints, one at each extremity of the rod. The joints function to provide rotational and angular movement around the sphere of the spherical pins of the ball and socket joints. This construction is designed to transmit the movements and strains between two points of the systems that need rotational and angular movements to which these tie bars are fastened by means of fixing of the spherical pin, even under conditions of relative movement between these points.

But, this conventional construction features undesirable aspects for the current state of the art of the motor vehicles, namely:

high costs due to the utilization of several components made of different materials and that require long time for their manufacturing, even taking into consideration the most automated techniques for their obtainment;

heavy weight due to the utilization of metal for the manufacturing of their body;

generation of noises due to wear on the plastic bearing and spherical pin surfaces that effect relative movement between themselves; and

decrease of the working life due to the penetration of impurities caused by the rupture of the protective dust cap.

It is known to provide a construction that solves the weight problem with the utilization of a body of plastic material loaded with fiber to increase rigidity. Such construction is obtained by the process of gas injection molding that results in a tubular body with an empty cavity in the interior of the central part that makes the connection between the extremities where the ball and socket joints are mounted. However, this construction features the inconvenience of the high costs of the injection molds, individually required for each variation of length, besides requiring the use of thermoplastics injecting machines equipped with units for gas injection. This process also results in higher cost in relation to those that are conventional in the market, thus hindering the return of the cost of development of them, besides preserving the other disadvantages already mentioned before, as, the tie bar according to this construction also features at its ends two ball and socket joints with bearing, spherical pin, dust cap, etc.

The prior art contemplates also another variation of construction of tie bars in which the body is formed by a rod, coupled by means of threads on their extremities and locked by nuts that are leaned by their tops on the face of the body of the ball and socket joints. Both the rod and the body of the ball and socket joints are generally made of metal to guarantee the level of mechanical resistance required to the accomplishing of their function of transmission of movements and strains, both rotational and angular. This solution presents versatility in the obtainment of several versions where only the length and/or details of the fixing varies in the other components of the suspension, in counterpart to the described option that utilizes the plastic body, but preserves all the other previously described disadvantages.

### SUMMARY OF THE INVENTION

This invention provides a tie bar having a rod made of polymeric materials reinforced with charges in the form of fibers, hereinafter denominated composites, utilizing the properties obtained with the combination of the mentioned materials and a metallic terminal for the rigid fixing of any kind and without the utilization of ball and socket joints at their extremities.

The properties of the composites improve performance when compared to metals due to the junction of the polymeric materials that are formed through irreversible chemical reactions of the type crossed between their molecular chains (such reactions commonly called cure process) with miscellaneous materials in the form of fibers such as fiber glass, carbon fiber, aramide fiber, among others. Specifically, the properties of the composites, that are of interest for this use, provide high mechanical resistance of traction and compression in the longitudinal direction of the tie bar body in combination with the torsion and flexion in elastic regimen, with limits several times higher to metal. The composites improve performance of the conjugated rotational and angular movements when compared to the conventional tie bars by the angular and rotational movement by the ball and socket joint by the swiveling of the spherical pin. Thus, the combination of these properties obtain a tie bar that performs the same functions of the conventional tie bars, while eliminating the several undesirable aspects for the current state of the art of the motor vehicles previously mentioned, which are inherent to the use of ball and socket joints at the extremities.

The invention simplifies construction as it eliminates all the components present in the ball and socket joints, contributing to the reduction of the manufacturing cost and elimination of noise resulting from the use, as the functions of providing rotational and angular movements are obtained by the torsion and flexion in the body of the tie bar. The invention further increases the working life of the tie bar as the fatigue of the composites is several times superior to that of the ball and socket joints present in the conventional tie bars.

It is highly important to emphasize that one of the problems present in the conventional tie bars, eliminated by the proposition of this invention, is the tendency to harm the protective dust cap that presents a high level of failure by slashes and perforations by debris present in the working environment of the tie bars. This type of failure substantially decreases the working life of the conventional tie bars in the sense that, with the failure of the dust cap, the interior of the ball and socket joint suffers significantly higher wear due to the presence of impurities and strange particles in the interior of the ball and socket joint. Such wear accelerates the appearance of slacks and noises that characterize sensation of inconvenience to the users of the vehicle. In one embodiment, the tie bar with composites comprises a cylindrical rod of composite together with metallic terminals chemically and/or mechanically fixed to their extremities. The chemical bond may be made by means of gluing, while the mechanical bond may be made by the pressing or clipping. The connection of the rod to the terminals may be made also by means of thread, through which the metallic terminals are fixed preceded by nuts which are leaned by the top on the face of the metallic terminals, by the threaded side, thus allowing to fulfill the regulating function of the length of the tie bar, as well as the locking of the terminals in the required length.

The composite may be prepared by the mixture of a polymeric base material associated to miscellaneous materials in the form of fibers such as fiber glass, carbon fiber, aramide fiber, among others, disposed so as to provide the already mentioned properties in the required values, according to each specific application. These fibers may be disposed in different positions: simple, braided, interweaved etc. in the longitudinal direction. The conformation of this rod in composite may be obtained in any cross section format, as well as any dimensioning of this profile, in this way facilitating the optimal dimensioning utilization that combines the required mechanical resistance with the minimum of cost and space for its assembling in the vehicle.

This is also a useful artifice in the balancing of the already mentioned properties of traction, compression, flexion and torsion. These materials further offer the characteristic of excellent chemical resistance, extremely desirable for this environment, as the places where these tie bars perform their function are subject to a great number of aggressive chemical compositions, such as solvents, oils, greases, etc. Their thermal resistance is another advantageous factor in relation to the conventional solutions of tie bars. This is due to the non-utilization of materials such as lubricating greases, rubber of the protective, caps and even the thermoplastic polymers of the spherical bearings.

All of these conventional materials have limitations of working temperature lower in relation to the temperature of the composites and metallic terminals utilized according to this patent of invention, making this solution more adequate to the current stage of the performance of the elements applied in the automotive industry that pursues more and more versatile solutions that indistinctly attend the most varied conditions of utilization of the globalized market.

The instant application claims foreign priority right based on Brazilian Patent Application No. PI 0200820-3 filed in Brazil on Feb. 27, 2002, which document is hereby incorporated by reference to thereby form part of this disclosure.

### BRIEF DESCRIPTION OF THE DRAWINGS

The attached drawings feature preferred embodiments of the invention, in which:

FIG. 1 is a partial longitudinal cross section view of a tie bar in which the metallic terminals are fixed to the extremities of the rod by chemical and/or mechanical process;

FIG. 2 is a partial longitudinal cross section view of a tie bar in which the metallic terminal is fixed to the extremity of the rod, by threading process.

FIG. 3 is a partial cross section of the metallic terminal according to this invention taken along section line III-III of FIG. 1.

### DETAILED DESCRIPTION OF PREFERRED EMBODIMENTS

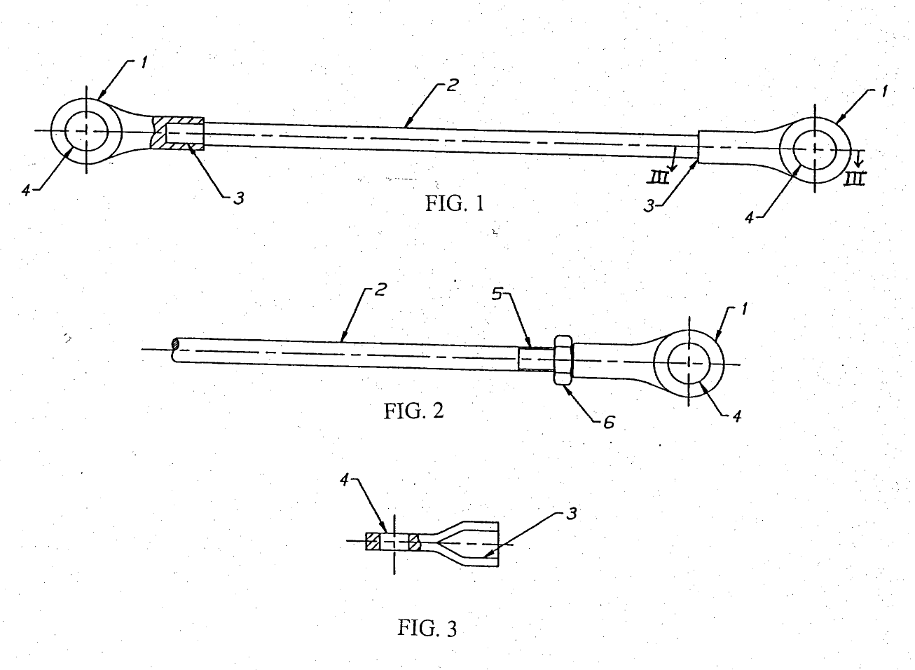

According to FIG. 1, the metallic terminals (1) must be provided with a longitudinal orifice (3) and a transverse orifice (4). The longitudinal orifice is formed with accurate and sufficient dimensions for the connection to the composite rod (2) so as to allow fixing of the rod in the longitudinal orifice (3) by chemical process, as, for example, gluing and/or mechanical, as, for example, pressing or clipping. The transverse orifice is formed in an eyelet defining a flat face provided to receive a screw that makes the function of the extremity of the spherical pin in the conventional tie bars that fixes itself to the component of the vehicle to be interconnected by the subject tie bar. A simple and low cost means for obtaining this type of metallic terminal is, as seen in the FIG. 3, through the smashing and execution of an orifice (4) in a metallic tube utilizing the very internal diameter (3) of the tube for the encasing in the composite rod (2).

According to this invention, the rod (2) of the tie bar is made of a composite that requires connecting elements that make possible both rotational and angular movement. More specifically, the tie bar is design for application in motor vehicles, wherein it is formed with a rod (2) constructed of composites defined by polymeric materials formed through irreversible chemical reactions of the type cross-connected between the molecular chains of the polymer constituent of this composite reinforced with charges in the form of fibers such as fiber glass, carbon fiber, aramide fiber, among others, disposed in any positioning in the interior of the profile. The rod (2) is coupled to a metallic terminal constructed as a tube with an internal diameter having accurate and sufficient dimension to enable connection of the terminal to the composite rod. The terminal is provided with an eyelet having a performed orifice on a flat surface obtained by the smashing of the tube in that extremity. The tube may, in one embodiment, be provide with a thread to fix to tie bar in the component of the vehicle that performs the rotational and angular movement.

Another possible construction form, as shown in the FIG. 2, is composed by a composite rod (2) according to what was described in the preceding proposition except by having threads (5) in its extremities to which the metallic terminals are fixed (1) preceded by nuts (6), on both sides of the rod (2), that abut and engage the top face of the metallic terminals (1) by the threaded side allowing in this manner to fulfill the function of length regulation in some tie bar applications, as well as the locking of these terminals in the required length.

While the foregoing invention has been shown and described with reference to specific embodiments, it will be understood by those of skill in the art that various changes in form and detail may be made therein without departing from the spirit and scope of the instant invention.

I claim:

1. Tie bar made of composite for utilization in mechanical systems that require connecting elements that make possible rotational and angular movement, more specifically, for application in motor vehicles, said tie bar comprising:
a rod constructed of polymeric materials denominated composites, formed through irreversible chemical reactions of the type crossed connections between the molecular chains of the polymer constituent of this composite reinforced with charges in the form of fibers selected from the group consisting of fiber glass, carbon fiber, and aramide fiber, disposed in any positioning in the interior of the profile and
a metallic terminal, said composite rod coupled to said metallic terminal which is formed as a tube-like constructed with an internal diameter with accurate and sufficient dimension for the connection to the composite rod so as to allow the fixing to the rod.

2. The tie bar according to claim 1, further comprising an eyelet with performed orifice on a flat surface obtained by the smashing of the tube in an extremity, intended to receive a thread for fixing itself in the component of the vehicle that needs the rotational and angular movement.

3. The tie bar according to claim 1, wherein the rod is coupled to the metallic terminals by chemical process, such as gluing, for example, through the use of product appropriate to the adhesion of the composite rod to the metallic terminals.

4. The tie bar according to claim 1, wherein the rod is coupled to the metallic terminals by mechanical process of pressing or clipping.

5. The tie bar according to claim 1, wherein the rod is coupled to the metallic terminals by means of a thread through which the metallic terminals are fixed preceded by nuts that abut a face of the body of the metallic terminals, by the threaded side, allowing in this manner to fulfill the function of regulation of the tie bar length, as well as the locking of the terminals in the required length.

6. The tie bar according to claim 1, wherein the rod is of format of profile and dimensioning, including with non-regular disposition of the fibers along the rod's profile.

7. The tie bar according to claim 1, wherein the rod is adapted to be coupled to the metallic terminals by chemical and mechanical process, in a joint form to assure greater coupling force.

8. The tie bar according to claim 1, wherein the metallic terminal is capable of being obtained by any other means that is not from an smashed tube.

9. The tie bar according to claim 1, wherein the terminal may be obtained from other materials such as, for example, of plastic.
